(19) United States
(12) Patent Application Publication
(10) Pub. No.: US 2024/0258615 A1
(43) Pub. Date: Aug. 1, 2024

(54) RECHARGEABLE BATTERY AND MANUFACTURING METHOD THEREOF

(71) Applicant: SAMSUNG SDI CO., LTD., Yongin-si (KR)

(72) Inventor: Dae Kyu KIM, Yongin-si (KR)

(21) Appl. No.: 18/237,088

(22) Filed: Aug. 23, 2023

(30) Foreign Application Priority Data
Jan. 27, 2023 (KR) 10-2023-0011179

(51) Int. Cl. H01M 50/124; H01M 10/04; H01M 50/107; H01M 50/121; H01M 50/131; H01M 50/152; H01M 50/167

(52) U.S. Cl. CPC H01M 50/1243; H01M 10/0422; H01M 50/107; H01M 50/121; H01M 50/131; H01M 50/152; H01M 50/167

(57) ABSTRACT

A rechargeable battery includes an electrode assembly; a can accommodating the electrode assembly and an electrolyte solution therein, the can including a body part having an opening, a bottom part connected to the body part, and a beading part on the body part in a region between the opening and the electrode assembly; a cap assembly that closes and seals the opening of the can and is connected to the can; and a super-hydrophobic coating film on the beading part, the super-hydrophobic coating film exhibiting super-hydrophobicity by exposing a plurality of nano materials at a surface thereof.

### CROSS-REFERENCE TO RELATED APPLICATION

This application claims priority to and the benefit of Korean Patent Application No. 10-2023-0011179 filed in the Korean Intellectual Property Office on Jan. 27, 2023, the entire contents of which are incorporated herein by reference.

### BACKGROUND

### 1. Field

Embodiments relate to a rechargeable battery and a manufacturing method thereof.

### 2. Description of the Related Art

Rechargeable batteries may be classified into, e.g., cylindrical, prismatic, and pouch-type depending on their shape. Among them, the cylindrical rechargeable battery may include a cylinder-shaped can having a bottom, an electrode assembly and an electrolyte solution accommodated inside the can, and a cap assembly that closes and seals the opening of the can.

### SUMMARY

The embodiments may be realized by providing a rechargeable battery including an electrode assembly; a can accommodating the electrode assembly and an electrolyte solution therein, the can including a body part having an opening, a bottom part connected to the body part, and a beading part on the body part in a region between the opening and the electrode assembly; a cap assembly that closes and seals the opening of the can and is connected to the can; and a super-hydrophobic coating film on the beading part, the super-hydrophobic coating film exhibiting super-hydrophobicity by exposing a plurality of nano materials at a surface thereof.

The beading part may include a first surface facing the cap assembly, a second surface facing the electrode assembly, and a third surface connecting the first surface and the second surface, and the super-hydrophobic coating film may be on the first surface and the third surface.

The body part of the can may further include an opening side vertical part between the opening and the beading part, and the super-hydrophobic coating film may be continuously on the opening side vertical part, the first surface of the beading part, and the third surface of the beading part.

The plurality of nano materials of the super-hydrophobic coating film may include polytetrafluoroethylene or silicone.

A contact angle of the electrolyte solution on the super-hydrophobic coating film may be 150° to 160°.

The embodiments may be realized by providing a manufacturing method of a rechargeable battery, the method including preparing a can such that the can includes a body part having an opening and a bottom part connected to the body part; disposing an electrode assembly inside the can; molding the body part to form a beading part; forming a super-hydrophobic coating film on the beading part; injecting an electrolyte solution into the can; disposing a gasket and a cap assembly on the opening side of the body part; and molding the body part to form a clamping part.

The beading part may include a first surface facing the opening, a second surface facing the electrode assembly, and a third surface connecting the first surface and the second surface, and the super-hydrophobic coating film may be on the first surface and the third surface.

The body part may further include an opening side vertical part between the opening and the beading part, and the super-hydrophobic coating film may be continuously on the opening side vertical part, the first surface of the beading part, and the third surface of the beading part.

Forming the super-hydrophobic coating film may include coating a coating solution including a plurality of nano materials and an organic solvent, and drying the coated coating solution.

Coating the coating solution may include applying the coating solution to a target area by contacting a coating cloth holding the coating solution to the target area while rotating the can.

Coating the coating solution may include applying the coating solution to a target area by rotating a coating cloth holding the coating solution along a circumferential direction of the can in a state that the coating cloth is in contact with the target area.

The plurality of nano materials in the coating solution may include polytetrafluoroethylene or silicone.

The organic solvent in the coating solution may include methanol, ethanol, acetone, ethylene carbonate, propylene carbonate, diethyl carbonate, dimethyl carbonate, or ethyl methyl carbonate.

The organic solvent in the coating solution includes the same components as an organic solvent of the electrolyte solution.

### BRIEF DESCRIPTION OF THE DRAWINGS

Features will be apparent to those of skill in the art by describing in detail exemplary embodiments with reference to the attached drawings in which:

FIG. 1 is a cross-sectional view of a rechargeable battery according to an exemplary embodiment of present disclosure.

FIG. 2 is a partial enlarged view of a rechargeable battery shown in FIG. 1.

FIG. 3 is an enlarged view showing a part of a can after forming a beading part of a rechargeable battery shown in FIG. 1.

FIG. 4 is a view showing a state in which a super-hydrophobic coating film is formed on a can of FIG. 3.

FIG. 5 is a view showing a part of a can of a comparative rechargeable battery.

FIG. 6 is a view to explain an action of a super-hydrophobic coating film on a can of FIG. 4.

FIG. 7 is a flowchart showing a manufacturing process of a rechargeable battery according to an exemplary embodiment of the present disclosure.

FIG. 8 is a partial enlarged view of a can showing a third step of a rechargeable battery manufacturing method shown in FIG. 7.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

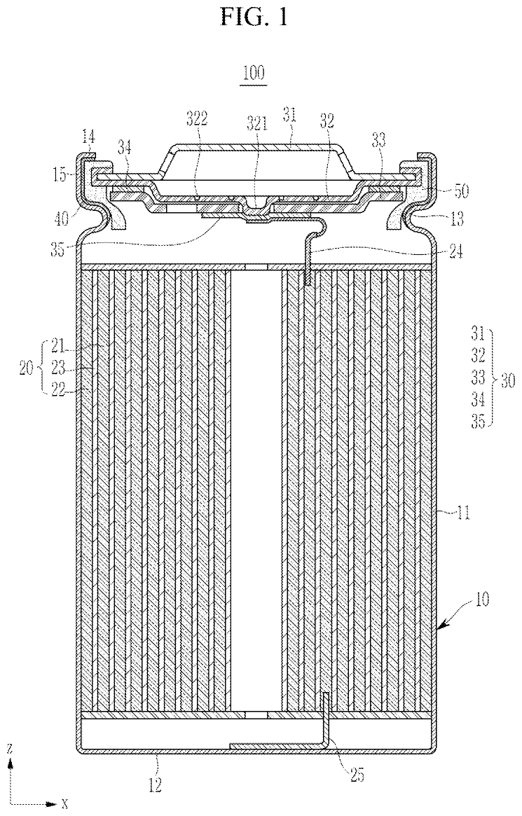

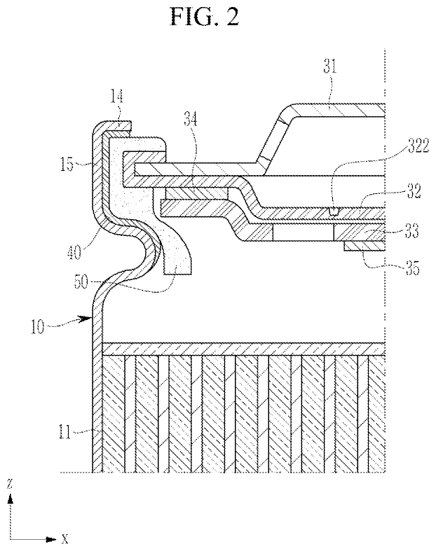

FIG. 1 is a cross-sectional view of a rechargeable battery according to an exemplary embodiment of present disclosure, and FIG. 2 is a partial enlarged view of the rechargeable battery shown in FIG. 1.

Referring to FIG. 1 and FIG. 2, a rechargeable battery 100 according to an exemplary embodiment may include a can 10 having a beading part 13, an electrode assembly 20 and an electrolyte solution accommodated into the side of the can 10, a cap assembly 30 closing and sealing the opening of the can 10, and a super-hydrophobic coating film 40 on the beading part 13.

The electrode assembly 20 may include a separator 23, a first electrode 21 and a second electrode 22 with the separator 23 therebetween, and may be wound in a jelly-roll form.

The first electrode 21 may include a first base material and a first active material layer on the first base material. In a first uncoated region where the first active material layer is not included, a first lead tab 24 may extend outwardly, and the first lead tab 24 may be electrically connected to the cap assembly 30.

The second electrode 22 may include a second base material and a second active material layer on the second base material. In a second uncoated region where the second active material layer of the second base material is not included, a second lead tab 25 may extend outwardly, and the second lead tab 25 may be electrically connected to the can 10. The first lead tab 24 and the second lead tab 25 may extend in opposite directions.

In an implementation, the first electrode 21 may function as a positive electrode. In this case, the first base material include, e.g., an aluminum foil, and the first active material layer may include, e.g., a transitional metal oxide. In an implementation, the second electrode 22 may function as a negative electrode. In this case, the second base material may include, e.g., a copper foil or a nickel foil, and the second active material layer may include, e.g., graphite.

The separator 23 may help prevent a short circuit between the first electrode 21 and the second electrode 22 while allowing the movement of lithium ions. The separator 23 may include, e.g., polyethylene film, polypropylene film, polyethylene-polypropylene film, or the like. As used herein, the term “or” is not an exclusive term, e.g., “A or B” would include A, B, or A and B.

The can 10 may accommodate the electrode assembly 20 and the electrolyte solution, and constitutes the external appearance of the rechargeable battery 100 together with the cap assembly 30. In an implementation, the can 10 may be generally cylindrical. Hereinafter, for convenience, the cylindrical rechargeable battery will be described as an example.

The can 10 may include a body part 11 (having an approximately cylinder-shape) and a bottom part 12 connected to one side (e.g., a lower side based on the drawing) of the body part 11. The other side of the body part 11 (e.g., an upper side based on the drawing) may be an open side. The electrode assembly 20 may enter through the opening of the can 10 and be accommodated inside the can 10.

The body part 11 may include a beading part 13 and a clamping part 14. The beading part 13 may be a part that is convexly deformed toward the inside of the body part 11 (e.g., inwardly deformed) and may be closer to the opening of the can 10 than the electrode assembly 20. The clamping part 14 may be at the open side edge part of the can 10 and may be bent downwardly/inwardly toward the inside of the body part 11.

The beading part 13 may help suppress the flow or movement of the electrode assembly 20 inside the can 10, and may facilitate the seating of the gasket 50 and the cap assembly 30. The clamping part 14 may help fix the cap assembly 30 by pressing the edge of the cap assembly 30 through the gasket 50. In an implementation, the can 10 may be constructed of, e.g., an iron plated with nickel.

The electrolyte solution may include a lithium salt and an organic solvent. In an implementation, the lithium salt may include, e.g., LiPF₆, LiBF₄, or the like. In an implementation, the organic solvent may include, e.g., ethylene carbonate (EC), propylene carbonate (PC), diethyl carbonate (DEC), dimethyl carbonate, DMC), ethyl methyl carbonate (EMC), or the like.

The cap assembly 30 may be fixed to the inside of the clamping part 14 through the gasket 50 to seal the can 10. In an implementation, the cap assembly 30 may include, e.g., a cap up 31, a safety vent 32, a cap down 33, an insulation member 34, and a sub plate 35.

The cap up 31 may be at an uppermost side of the cap assembly 30. The cap up 31 may include a terminal part that convexly protrudes upwardly and may be connected to an external circuit or load, and an outlet for discharging a gas may be around the terminal part.

The safety vent 32 may be under the cap up 31. The safety vent 32 may include a protruded part 321 that is convexly protruded downwardly and connected to the sub plate 35, and at least one notch 322 around the protruded part 321.

If a gas is generated, e.g., due to an overcharge or an abnormal operation of the rechargeable battery 100, the protruded part 321 may be deformed upwardly by the pressure and separated from the sub plate 35, and the safety vent 32 may be incised or break along the notch 322. The incised safety vent 32 may release gas to the outside to prevent the explosion of the rechargeable battery 100.

The cap down 33 may be under the safety vent 32. A first opening to expose the protruded part 321 of the safety vent 32 and a second opening to discharge gas may be in the cap down 33. The insulation member 34 may be between the safety vent 32 and the cap down 33 to insulate the safety vent 32 and the cap down 33.

The sub plate 35 may be under the cap down 33. The sub plate 35 may be fixed to the lower surface of the cap down 33 to help block the first opening of the cap down 33, and the protruded part 321 of the safety vent 32 may be fixed to the sub plate 35. The first lead tab 24 (drawn out from the electrode assembly 20) may be fixed to the sub plate 35. In an implementation, the cap up 31, the safety vent 32, the cap down 33, and the sub plate 35 may be electrically connected to the first electrode 21 of the electrode assembly 20.

The manufacturing process of the above-mentioned rechargeable battery 100 may roughly include disposing the electrode assembly 20 inside the can 10, molding the beading part 13 in the can 10, injecting the electrolyte solution into the can 10, and disposing the gasket 50 and the cap assembly 30 on the beading part 13, and fixing the cap assembly 30 by molding the clamping part 14 on the can 10. Before the electrolyte solution injection, the second lead tab 25 of the electrode assembly 20 may be fixed to the bottom part 12 of the can 10 by a welding, and when the cap assembly 30 is disposed on the beading part 13, the first lead tab 24 may be fixed to the cap assembly 30 by the welding.

In the process of injecting the electrolyte solution, the electrolyte solution could remain on the beading part 13. The beading part 13 may be convexly deformed toward the inside of the can 10, the interior diameter of the can 10 may be the smallest at the beading part 13, and the electrolyte solution could easily remain on the beading part 13. If the beading part 13 were to be contaminated by the electrolyte solution, welding defects could occur in the process of fixing the first lead tab 24 and the cap assembly 30 by the welding, and the welding defects could lead to manufacturing defects of the rechargeable battery.

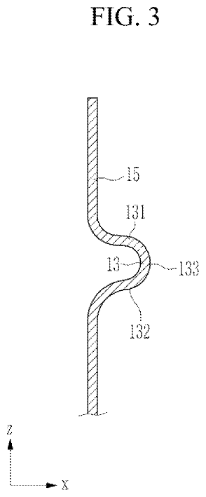

FIG. 3 is an enlarged view showing a part of a can right after forming a beading part in the rechargeable battery shown in FIG. 1.

Referring to FIG. 1 and FIG. 3, the can 10 may include the body part 11 and the bottom part 12, and the beading part 13 may be formed by a beading process at a certain distance from the opening of the body part 11. Before the crimping process (for forming the clamping part 14), the entire body part 11 (except for the beading part 13) may be parallel to the axis direction of the rechargeable battery (the z-axis direction of the drawing). In an implementation, the area between the opening of the body part 11 and the beading part 13 is referred to as an opening side vertical part 15.

The beading part 13 may generally include a first surface 131 facing the cap assembly 30, a second surface 132 facing the electrode assembly 20, and a third surface 133 connecting the first surface 131 and the second surface 132. The first surface 131 and the second surface 132 may include a relatively flatter portion, and the third surface 133 may include a curved surface such as a semicircle or circular arc (arc).

In an implementation, the entire beading part 13 may be composed of a curved surface such as a semicircle or circular arc without a relatively flatter portion. Even in this case, the beading part 13 may be a portion that generally faces the cap assembly 30 (corresponding to the first surface 131), a portion that generally faces the electrode assembly 20 (corresponding to the second surface 132), and the portion (corresponding to the third surface 133) connecting two portions.

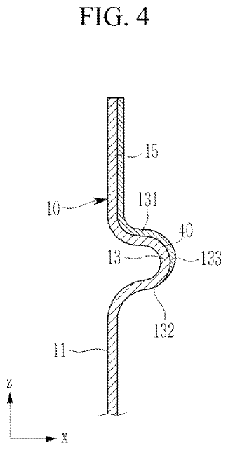

FIG. 4 is a view showing a state in which a super-hydrophobic coating film is formed on the can shown in FIG. 3.

Referring to FIG. 4, the super-hydrophobic coating film 40 may be on the beading part 13. A super-hydrophobic means that the surface has a very large or strong hydrophobic (e.g., liquid repelling) surface, making it difficult to get wet (e.g., by the solvent of the electrolyte). The contact angle of a water droplet to the super-hydrophobic surface of a solid material may exceed 150°, and a water or liquid droplet falling on the super-hydrophobic surface may bounce completely like a ball with elasticity.

The super-hydrophobic coating film 40 may be on the first surface 131 and the third surface 133 of the beading part 13, or may be continuously positioned over the opening side vertical part 15, and the first surface 131 and the third surface 133 of the beading part 13. The part where the super-hydrophobic coating film 40 is on the inner surface of the can 10 may realize the contact angle greater than 150° and minimize a frictional force. In an implementation, even if the electrolyte solution were to bounce on the beading part 13 during the electrolyte solution injection process, the electrolyte solution may quickly fall downward due to the surface characteristics of the super-hydrophobic coating film 40 and, as a result, the electrolyte solution may not remain on the beading part 13.

The super-hydrophobic coating film 40 may include a plurality of nano materials having a nanometer scale of 1 nm or more and less than 1,000 nm. The plurality of nano materials may include, e.g., polytetrafluoroethylene or silicone. The super-hydrophobic coating film 40 may be produced by a process coating a mixture of the nano materials and an organic solvent and then drying. During the drying process, a volatilization of the organic solvent may expose the nano material to the surface, thereby realizing the super-hydrophobic coating film 40.

The contact angle of the electrolyte solution on the super-hydrophobic coating film 40 may be, e.g., 150° to 160°. In general, when the contact angle of a water droplet to the surface of a solid material is 1500 or more, it is referred to as being super-hydrophobic. In an implementation, the super-hydrophobicity may behave the same for the electrolyte solution (e.g., other than water). In an implementation, the super-hydrophobic coating film 40 may facilitate the contact angle of 1500 or more with respect to the electrolyte solution, and may facilitate quick dropping the electrolyte solution.

As the contact angle of the electrolyte solution relative to or on the super-hydrophobic coating film 40 become larger, it is possible that the electrolyte solution may fall faster. However, there may be no, or only an insignificant, difference compared to the case where the contact angle is 150°. Table 1, below, shows measurement results of the contact angles of the electrolyte solution depending on a change in the thickness of the super-hydrophobic coating film 40 and drying conditions, and the contact angles of the electrolyte solutions shown in Table 1 are in the range of 1500 to 160°. As such, the contact angle of the electrolyte solution that may be implemented in the rechargeable battery 100 of the exemplary embodiment belongs to the range of 150° to 160°.

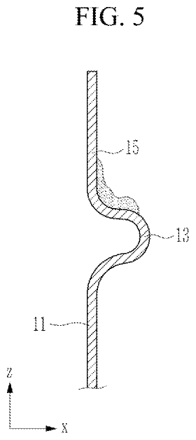

FIG. 5 is a view showing a part of a can of a comparative rechargeable battery.

Referring to FIG. 5, the comparative rechargeable battery may have the same composition as the rechargeable battery of the exemplary embodiment except that the super-hydrophobic coating film is omitted.

In the comparative rechargeable battery, during the electrolyte solution injection process, the electrolyte solution may remain in the concave space between the opening side vertical part 15 and the beading part 13 of can 10, and the residual electrolyte solution may remain on the beading part 13 continuously and contaminate the beading part 13 unless a separate removal operation were to be performed. The contamination of the beading part 13 could lead to a poor welding of the first lead tab and a cap assembly.

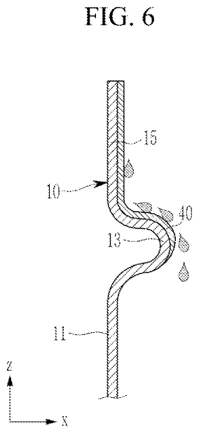

FIG. 6 is a view to explain an action of a super-hydrophobic coating film on the can shown in FIG. 4.

Referring to FIG. 6, the super-hydrophobic coating film 40 may be on the opening side vertical part 15 of the can 10 and the first surface 131 and the third surface 133 of the beading part 13, thereby realizing the contact angle greater than 1500 and minimizing the friction force at the same time. Therefore, even if the electrolyte solution were to splash on the super-hydrophobic coating film 40 during the electrolyte solution injection process, the electrolyte solution may not stay on the super-hydrophobic coating film 40 and may quickly fall or drain down.

Again, referring to FIG. 1, the exemplary embodiment of the rechargeable battery 100 may help suppress the contamination of the beading part 13 by the electrolyte solution, and may help effectively suppress the welding defects of the first lead tab 24 and the cap assembly 30. In addition, the rechargeable battery 100 of the exemplary embodiment may not require a separate process of removing a residual electrolyte solution after the electrolyte solution injection process.

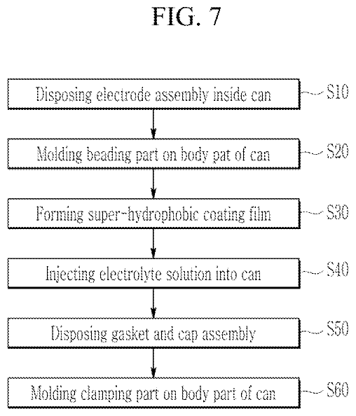

FIG. 7 is a flowchart showing a manufacturing process of a rechargeable battery according to an exemplary embodiment of the present disclosure.

Referring to FIG. 7, the manufacturing method of the rechargeable battery may include, e.g., a first step (S10) of preparing a can including a body part and a bottom part and disposing an electrode assembly inside the can, a second step (S20) of molding a beading part on the body part, a third step (S30) of forming a super-hydrophobic coating film on the beading part, a fourth step (S40) of injecting an electrolyte solution inside the can, a fifth step (S50) of disposing a gasket and a cap assembly on an opening side of the can, and a sixth step (S60) of molding a clamping part on the body part.

Referring to FIG. 1, in the first step (S10), the can 10 may basically include the body part 11 and the bottom part 12, and an electrode assembly 20 (wound in a form of a jelly roll) may be accommodated inside the can 10. In an implementation, the second lead tab 25 of the electrode assembly 20 may be fixed to the bottom part 12 of the can 10 by welding. In the second step (S20), the can 10 may be put into a beading forming device, and a part of the body part 11 close to the opening may be deformed inwardly by an external force to form a beading part 13.

Referring to FIG. 3, in the second step (S20), the beading part 13 may include a first surface 131 generally positioned or facing toward the opening, a second surface 132 facing the electrode assembly 20, and a third surface 133 connecting the first surface 131 and the second surface 132, and an opening side vertical part 15 may be between the opening of the can 10 and the first surface 131 of the beading part 13.

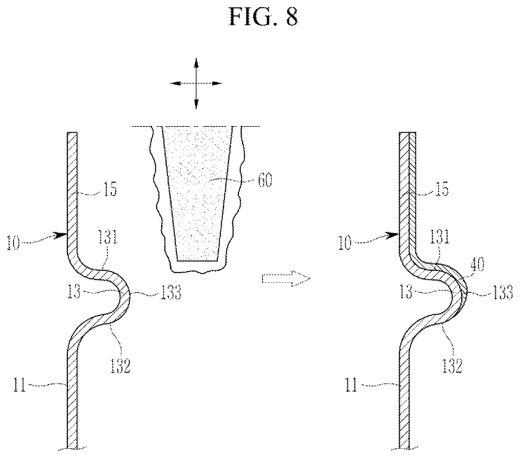

FIG. 8 is a partial enlarged view of a can showing a third step of a rechargeable battery manufacturing method shown in FIG. 7.

Referring to FIG. 8, the third step (S30) of forming the super-hydrophobic coating film 40 may include a coating process of coating a coating solution to the beading part 13 by using a coating device and a drying process of drying the coating solution. The coating solution may include an organic solvent in which nano materials are dispersed, and the organic solvent may volatilize during the drying process, thereby exposing the nano materials to the surface. In the super-hydrophobic coating film 40, the super-hydrophobicity may be realized by the nano materials exposed on the surface, and the contact angle of the electrolyte solution on the super-hydrophobic coating film 40 may be 150° to 160°.

The coating device may include a first rotator that holds and rotates the can 10, and a coating cloth 60 that holds the coating solution and then contacts the beading part 13 to apply the coating solution to the contact area. In an implementation, the coating device may include a coating cloth 60 holding the coating solution and a second rotator that rotates the coating cloth 60 along the circumferential direction of the can 10.

In an implementation, the coating cloth 60 may include, e.g., a non-woven fabric. In an implementation, the coating device may have a suitable configuration in which the coating solution may be applied to the coating object. The coating solution may be coated onto the first surface 131 and the third surface 133 of the beading part 13 by the coating device or may be coated over the opening side vertical part 15 and the first surface 131 and the third surface 133 of the beading part 13.

The organic solvent in the coating solution may include, e.g., methanol, ethanol, acetone, ethylene carbonate (EC), propylene carbonate (PC), diethyl carbonate (DEC), dimethyl carbonate (DMC), or ethyl methyl carbonate (EMC). The nano material in the coating solution may include, e.g., polytetrafluoroethylene (PTFE) or silicone.

The drying process may be performed at a temperature higher than a room temperature, e.g., may be performed under a temperature condition of approximately 60° C. When the temperature is determined, the degree of the drying of the coating solution may be controlled according to the drying time. Through the coating and drying processes, the super-hydrophobic coating film 40 may be formed over or on the opening side vertical part 15 of the can 10, and the first surface 131 and the third surface 133 of the beading part 13.

At this time, if the coating solution includes an organic solvent of the same component as the electrolyte solution, even if the remaining organic solvent that is not dried from the coating solution were to flow into the electrode assembly 20, the effect on the electrode assembly 20 may be reduced because it is the same component as the electrolyte solution.

Again, referring to FIG. 6, in the fourth step (S40), the electrolyte solution may be injected into the can 10, and during this process, some of the electrolyte solution could remain around or otherwise contact the beading part 13. However, due to the surface characteristics of the super-hydrophobic coating film 40 described above, the electrolyte solution may not stay on the surface of the super-hydrophobic coating film 40 and may quickly fall or drain down. As a result, the contamination of the beading part 13 by the residual electrolyte solution may be suppressed.

Again, referring to FIG. 1 and FIG. 2, in the fifth step (S50), the gasket 50 and the cap assembly 30 may be disposed at the opening of the can 10 onto the beading part 13. In the process of disposing the cap assembly 30, the first lead tab 24 of the electrode assembly 20 may be fixed to the cap assembly 30 by welding. In an implementation, the first lead tab 24 may be fixed to the protruded part 321 of the safety vent 32.

In the sixth step (S60), the can 10 may be put into a crimping device, and the opening side edge of the body part 11 may be bent inward by an external force, thereby forming a clamping part 14. The clamping part 14 may firmly fix the cap assembly 30 to the can 10 by pressing the edge of the cap assembly 30 through the gasket 50.

The table below shows test results of the contact angle depending on a thickness of the coating solution and the drying condition. Contact angle experiments were performed with water, a first electrolyte solution, and a second electrolyte solution.

TABLE 1

| | | | First | Second |
|---|---|---|---|---|
| | | Water | electrolyte | electrolyte |
| | | contact | solution | solution |
| | coating solution thickness/ | angle | contact | contact |
| No. | drying condition | (°) | angle (°) | angle (°) |
| 1 | coating one time 10 μm/no | 120 | 110 | 100 |
| | drying | | | |
| 2 | coating two times 20 μm/no | 130 | 135 | 125 |
| | drying | | | |
| 3 | coating three times 30 μm/no | 145 | 143 | 145 |
| | drying | | | |
| 4 | coating one time 10 μm/60° C. 10 | 150 | 155 | 151 |
| | seconds | | | |
| 5 | coating two times 20 μm/60° C. | 158 | 154 | 150 |
| | 10 seconds | | | |
| 6 | coating three times 30 μm/60° C. | 160 | 160 | 160 |
| | 10 seconds | | | |

The first electrolyte solution used in the experiment included ethylene carbonate (EC), ethyl methyl carbonate (EMC) and dimethyl carbonate (DMC), and their mixing ratio was as follows.

$$EC / EMC / DMC = 20 / 10 / 70$$

The second electrolyte solution contained ethylene carbonate (EC), polypropylene carbonate (PC), ethyl propiolate (EP), and propyl propiolate (PP), and their mixing ratio was as follows.

$$EC / PC / EP / PP = 15 / 15 / 30 / 40$$

Experiment Nos. 1 to 3 are cases in which the drying did not proceed after the coating solution was applied. In this case, the contact angles of water, and the first electrolyte solution and the second electrolyte solution were all less than 150°, indicating that it was not suitable as a super-hydrophobic coating film.

Experiment Nos. 4 to 6 are cases in which the solvent was volatilized by a drying process after the coating solution was applied. In this case, the contact angles of water, the first electrolyte solution, and the second electrolyte solution were all greater than 150°, and it may be seen that the super-hydrophobicity was achieved. This means that the nanomaterials were exposed to the surface due to the volatilization of the solvent and realized the super-hydrophobic surface.

As above-described, the rechargeable battery 100 of an exemplary embodiment may help suppress the remaining electrolyte solution on the beading part 13 by using the super-hydrophobic coating film 40, and the contamination of the beading part 13 by the electrolyte solution may be prevented. Therefore, the manufacturing quality of the rechargeable battery 100 may be improved by suppressing welding defects of the first lead tab 24 and the cap assembly 30.

By way of summation and review, after the electrode assembly is accommodated inside the can, a part of the can close to the opening of the can may be deformed inwardly by a beading process to become a beading part. Then, the electrolyte solution may be injected into the inside of the can, a gasket and a cap assembly may be positioned above the beading part, and the edge of the opening side of the can may be bent inward by a crimping process to become a crimping part.

The electrolyte solution could remain on the surface of the beading part after the electrolyte solution is injected, and welding defects could occur during the process of welding the positive lead and the cap assembly due to a contamination of the beading part by the residual electrolyte solution.

One or more embodiments may provide a rechargeable battery and a manufacturing method thereof that may help prevent contamination of the beading part caused by residual electrolyte solution.

The rechargeable battery of the exemplary embodiment may help suppress or prevent electrolyte solution from remaining on the beading part by using the super-hydrophobic coating film, and may help prevent the contamination of the beading part by the electrolyte solution. Therefore, the manufacturing quality of the rechargeable battery may be improved by suppressing welding defects of the first lead tab and the cap assembly.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly;
a can accommodating the electrode assembly and an electrolyte solution therein, the can including:
a body part having an opening,
a bottom part connected to the body part, and
a beading part on the body part in a region between the opening and the electrode assembly;
a cap assembly that closes and seals the opening of the can and is connected to the can; and
a super-hydrophobic coating film on the beading part, the super-hydrophobic coating film exhibiting super-hydrophobicity by exposing a plurality of nano materials at a surface thereof.

2. The rechargeable battery as claimed in claim 1, wherein:
the beading part includes a first surface facing the cap assembly, a second surface facing the electrode assembly, and a third surface connecting the first surface and the second surface, and
the super-hydrophobic coating film is on the first surface and the third surface.

3. The rechargeable battery as claimed in claim 2, wherein:
the body part of the can further includes an opening side vertical part between the opening and the beading part, and
the super-hydrophobic coating film is continuously on the opening side vertical part, the first surface of the beading part, and the third surface of the beading part.

4. The rechargeable battery as claimed in claim 1, wherein the plurality of nano materials of the super-hydrophobic coating film include polytetrafluoroethylene or silicone.

5. The rechargeable battery as claimed in claim 1, wherein a contact angle of the electrolyte solution on the super-hydrophobic coating film is 1500 to 160°.

6. A manufacturing method of a rechargeable battery, the method comprising:
preparing a can such that the can includes a body part having an opening and a bottom part connected to the body part;
disposing an electrode assembly inside the can;
molding the body part to form a beading part;
forming a super-hydrophobic coating film on the beading part;
injecting an electrolyte solution into the can;
disposing a gasket and a cap assembly on the opening side of the body part; and
molding the body part to form a clamping part.

7. The manufacturing method of the rechargeable battery as claimed in claim 6, wherein:
the beading part includes a first surface facing the opening, a second surface facing the electrode assembly, and a third surface connecting the first surface and the second surface, and
the super-hydrophobic coating film is on the first surface and the third surface.

8. The manufacturing method of the rechargeable battery as claimed in claim 7, wherein:
the body part further includes an opening side vertical part between the opening and the beading part, and
the super-hydrophobic coating film is continuously on the opening side vertical part, the first surface of the beading part, and the third surface of the beading part.

9. The manufacturing method of the rechargeable battery as claimed in claim 6, wherein forming the super-hydrophobic coating film includes:
coating a coating solution including a plurality of nano materials and an organic solvent, and
drying the coated coating solution.

10. The manufacturing method of the rechargeable battery as claimed in claim 9, wherein coating the coating solution includes applying the coating solution to a target area by contacting a coating cloth holding the coating solution to the target area while rotating the can.

11. The manufacturing method of the rechargeable battery as claimed in claim 9, wherein coating the coating solution includes applying the coating solution to a target area by rotating a coating cloth holding the coating solution along a circumferential direction of the can in a state that the coating cloth is in contact with the target area.

12. The manufacturing method of the rechargeable battery as claimed in claim 9, wherein the plurality of nano materials in the coating solution include polytetrafluoroethylene or silicone.

13. The manufacturing method of the rechargeable battery as claimed in claim 9, wherein the organic solvent in the coating solution includes methanol, ethanol, acetone, ethylene carbonate, propylene carbonate, diethyl carbonate, dimethyl carbonate, or ethyl methyl carbonate.

14. The manufacturing method of the rechargeable battery as claimed in claim 13, wherein the organic solvent in the coating solution includes the same components as an organic solvent of the electrolyte solution.
